(19) United States
(12) Patent Application Publication
(10) Pub. No.: US 2026/0185605 A1
(43) Pub. Date: Jul. 2, 2026

(54) LUBRICATING DEVICE FOR A PLANETARY GEAR BEARING OF A PLANETARY TRANSMISSION, AND PLANETARY TRANSMISSION

(71) Applicant: Schaeffler Technologies AG & Co. KG, Herzogenaurach (DE)

(72) Inventors: Frederic Fischer, Weisendorf (DE); Niklas Kretschmer, Gerhardshofen (DE)

(73) Assignee: Schaeffler Technologies AG & Co. KG, Herzogenaurach (DE)

(21) Appl. No.: 18/862,585

(22) PCT Filed: Apr. 26, 2023
(86) PCT No.: PCT/DE2023/100303

§ 371 Date: Nov. 4, 2024

(30) Foreign Application Priority Data
May 5, 2022 (DE) 10 2022 111 090.7

(51) Int. Cl. F16H 57/04; F16H 57/08

(52) U.S. Cl. CPC F16H 57/0479; F16H 57/0482; F16H 57/082; F16H 2057/085

(57) ABSTRACT

A lubricating device for a planetary transmission includes a planetary carrier including two carrier webs, a bearing pin arranged on the carrier webs, a bearing arranged on the bearing pin, a planetary gear mounted via the bearing, and two thrust plates arranged on either side of the planetary gear. One of the carrier webs includes a first channel-like depression arranged on a surface facing the planetary gear and arranged to feed a lubricant from radially outside of the thrust plate to the bearing. The other carrier web includes a second channel-like depression arranged on a surface facing the planetary gear and arranged to discharge the lubricant from the bearing radially outside. The first depression is arranged offset and radially further inward than the second depression such that the lubricant flows via the first channel-like depression, axially through the anti-friction bearing, and is drained via the second channel-like depression.

### CROSS-REFERENCE TO RELATED APPLICATIONS

This application is the United States National Phase of PCT Appln. No. PCT/DE2023/100303 filed Apr. 26, 2023, which claims priority to German Application No. DE102022111090.7 filed May 5, 2022, the entire disclosures of which are incorporated by reference herein.

### TECHNICAL FIELD

The present disclosure relates to a lubricating device for a planetary gear bearing of a planetary transmission with a planetary carrier comprising two carrier webs, at least one bearing pin arranged on the carrier webs, an anti-friction bearing arranged on the bearing pin, a planetary gear mounted via the anti-friction bearing and two thrust plates which are arranged on both sides of the planetary gear between the planetary gear and the carrier web.

### BACKGROUND

Planetary transmissions are used in a wide variety of fields, for example in motor vehicles and there, for example, in a transmission or a drive train of an electric drive, in particular an electric axle, or a hybrid drive train. Such a planetary transmission, as known for example from DE 197 36 686 A1, usually has a planetary carrier with at least one, but usually a plurality of planetary gears which are arranged eccentrically and offset from one another in the circumferential direction and which are mounted on bearing pins provided on the carrier side via respective anti-friction bearings. An annular thrust plate is arranged between the planetary gear or the anti-friction bearing and the planetary carrier, which is formed, for example, by means of two parallel webs, and allows at least the axial contacting of the axially slightly displaceable planetary gear. The anti-friction bearing, which includes a cage in or on which a plurality of rolling bodies, usually cylindrical needles, are received or guided, can optionally also run axially against such a thrust plate.

Since the planetary gear rotates during operation, lubrication of the bearing region with a lubricant is necessary. For this purpose, it is known (see, for example, the planetary transmission known from DE 197 36 686 A1) to feed the lubricant, usually oil, via the bearing pin, which is designed as a hollow pin and has an axial bore and at least one radial bore, so that the lubricant can be fed axially to the pin and exit radially into the bearing region. In order to direct the lubricant into the hollow bearing pin, a lubricant-collecting tray must generally be provided, which catches the lubricant and directs it laterally outside the planetary carrier. The lubricant-collecting tray is connected to the bearing pin so that the lubricant can be guided directly into the bearing pin via the collecting tray. This means that a considerable amount of effort has to be made to realize a corresponding lubricant supply to the bearing region, since on the one hand special, drilled pins have to be used and on the other hand a corresponding supply structure comprising a lubricant-collecting tray has to be arranged and corresponding precautions for fastening same and the like have to be taken.

### SUMMARY

The present disclosure provides an improved lubricating device for a planetary gear bearing of a planetary transmission.

The present disclosure provides a lubricating device of the type mentioned at the outset having at least one channel-like depression introduced into the surface facing the planetary gear on at least one carrier web, via which depression a lubricant fed from radially outside the thrust plate can be fed to the bearing region in the region between the thrust plate and the carrier web, or a lubricant which flows from the bearing region can be discharged radially to the outside in the region between the thrust plate and the carrier web.

In the lubricating device according to the disclosure, the lubricant is fed directly from the sun gear side, i.e., the lubricant is fed to the planetary gears from radially inside the planetary gear set. In order to be able to feed the lubricant fed from the radial inside to the bearing region, the disclosure provides for the formation of a defined lubrication channel in the region between a thrust plate and a carrier web of the planetary carrier, wherein this channel is open radially outwards. For this purpose, the surface of at least one carrier web facing the planetary gear is provided with a channel-like depression which is open at least radially outwards, thus allowing entry from the sun gear side when lubricant is fed radially. In this lubrication channel, the lubricant is then transported into the bearing or rolling region, where it is then distributed accordingly.

Viewed axially, a thrust plate is provided adjacent to the carrier web, which bears against the carrier web in the case of contact. Since the lubrication channel in the carrier web is introduced via a depression in the surface, this lubrication channel is always open such that lubricant can always be fed through it. It is of course conceivable to also form corresponding guide structures on the thrust plate in order to further increase the radial opening cross-section, such that a correspondingly larger, radially open lubrication gap is formed, part of which is then also the channel-like depression or with which this depression communicates so that overall the volume of lubricant that can be fed can be increased accordingly.

However, it is also conceivable to form such a channel-like depression in a carrier web for the purpose of discharging lubricant from the rolling region. This depression allows the lubricant to be discharged radially to the outside after it has flowed through the bearing. Again, a thrust plate is provided adjacent to the depression, and is also provided with a corresponding lubricant guide structure if required. In any case, however, a corresponding supply of the flowing lubricant into the channel-like depression is possible, which may also be part of a larger-volume lubricant guide structure that is open radially outwards.

Overall, the design of the lubricating device according to the disclosure makes it possible to improve the lubricant supply to the rolling region, since one or both carrier webs can be integrated into the radial lubricant feed and the radial lubricant discharge via their channel-like depressions, which supports the centrifugally driven lubricant supply.

If only one depression is provided in a carrier web, this depression may be positioned in such a way that it enables an improved lubricant feed to the rolling region and it is therefore possible to feed the lubricant radially from the sun gear side. By means of such an integrated lubricating device, it is then possible to realize a simplified lubricant supply without the use of specific bearing pins or other supply components. This is because neither hollow-drilled bearing pins nor a lubricant-collecting tray or other precautions are required. In the simplest design, only the corresponding channel-like depression in the carrier web needs to be provided, via which a corresponding supply channel is formed, which enables the radial inflow of lubricant, if necessary in conjunction with or supported by a lubricant guide structure on the adjacent thrust plate. The lubricant or channel structure realized with the aid of necessarily provided components, namely the carrier web, possibly in conjunction with the thrust plate, therefore enables a direct lubricant feed or a direct radial lubricant flow into the bearing region without additional components.

According to a further development, at least one channel-like depression is provided on both carrier webs, which are arranged offset from one another about the axis of the bearing pin, the one depression being disposed radially further inward in relation to the axis of rotation of the planetary transmission than the other depression. A channel-like depression and consequently a channel structure may be provided, e.g., embossed, on both carrier webs. However, the two depressions are offset from each other in the circumferential direction, in relation to the bearing axis of the planetary pin. One depression is arranged radially further inward in relation to the axis of rotation of the planetary transmission, while the other, in contrast, is positioned radially further outward. This makes it possible to define an inlet side and an outlet side.

On the inlet side, the channel-like depression is positioned further inward, i.e., closer to the central planetary transmission axis, so that the fluid flowing in from the sun gear side has a shorter path and can therefore flow directly into the channel structure which is open radially towards the sun side. The channel-like depression formed on the other carrier web is arranged offset therefrom, preferably by 180°, and is thus spaced further away from the sun gear side. This defines the outlet side because, after the lubricant is driven radially outwards, it allows for easier lubricant outflow. The two depressions may be arranged offset from each other by 180° around the circumference of the pin.

The depressions are expediently elongated and their longitudinal axes run perpendicular to the axis of rotation of the planetary transmission. They run radially to the central axis, but are offset from each other by 180°.

The carrier webs each have a through-hole into which the bearing pin is inserted. The two channel-like depressions expediently open at the through-hole, i.e., directly at the bearing pin, so that the fluid flowing in from the radial inside, i.e., the sun gear side, on the inlet side can flow directly to the bearing pin and from there can then be distributed axially, provided that it is not already guided axially into the bearing region beforehand. On the outlet side, the lubricant can also flow directly from the bearing pin into the lubrication channel on the web side and be discharged.

According to a development of the disclosure, as already described, there is a lubricant gap which is open radially outwards at least between the carrier web that has a depression adjacent thereto and the thrust plate and via which the lubricant can be fed or discharged. As described, a lubricant guide structure may be formed by a corresponding design of the thrust plate adjacent to a depression, and is designed as a radially open gap or channel structure, i.e., corresponding gaps are formed on both the inlet side and the outlet side if such depressions are provided on both sides, with the gaps defining a correspondingly large opening cross-section. This may be advantageous on the inlet side, as a sufficiently large amount of lubricant can be fed from the sun gear side, which can then be distributed in the rolling region via this lubricant guide structure, part of which is also the depression in the carrier web. Such a structure is also useful on the outlet side in order to be able to discharge an appropriate amount of lubricant.

To form such a lubricant guide structure, it is conceivable that the thrust plate has a plate main body, and, on a first plate side of the plate main body, a plurality of pocket-like first depressions which are open towards the outer circumference and closed towards the inner circumference are provided. Optionally, a plurality of pocket-like second depressions which are open towards the inner circumference and closed towards the outer circumference are provided. On an opposite second plate side flat, first and second elevations which correspond to the first and second depressions are provided. Surface sections of the plate main body which are disposed between the first depressions form a segmented first thrust plate and, optionally, surface sections of the plate main body which are disposed between the second depressions of the plate main body form a segmented second contact surface. The first and second elevations are spaced apart from one another in such a way so as to produce a channel structure which is open from the outer circumference to the inner circumference.

The thrust plate is therefore profiled with corresponding depressions and elevations, with this profile defining a radially open channel structure on the one hand, but also corresponding contact surfaces on the other hand. If such a separate thrust plate is used, the thrust plate bears against a carrier web with the elevations raised from the plate main body. The opposite side of the plate main body, on the other hand, forms the corresponding contact surfaces, namely a radially outer one for the planetary gear and a radially inner one for the cage of the anti-friction bearing, which, depending on the design of the axial plate, is arranged completely within the planetary gear bore, i.e., is as flush with it as possible, or which can also protrude slightly axially from the planetary gear.

The elevations, which form pockets that are closed radially inwards and, if provided, also radially outwards, form a channel structure that overall is open radially outwards and inwards, allowing radial inflow and radial outflow. This channel structure or gap structure also communicates with the web-side depression. Lubricant received in the closed pockets can be held there and serves as a lubricant reservoir via which, after these pockets are open to the planetary gear or the cage, the gear and the cage are lubricated accordingly in the case of contact, i.e., this contact zone is also supplied with lubricant. It should be noted that the radially inner, second depressions are not mandatory; rather, the undeformed plate main body can also be provided in the inner circumferential region so as to produce an annular plate surface as the second contact surface supporting the cage. However, the formation of the depressions and thus of the elevations on the other side is useful for supporting the thrust plate on the web.

If first and second depressions are present, they may be arranged in a staggered manner and, for example, overlap one another when viewed in the circumferential direction so as to produce a corresponding channel structure which extends from the radial outside to the radial inside and is not interrupted at any point, but at most is slightly angled due to a possible overlap.

Depending on whether the cage is flush with the end face of the planetary gear, i.e., the width of the cage corresponds at most to the width of the planetary gear, as viewed axially, or whether the cage is slightly wider and therefore protrudes slightly axially on one or both sides of the planetary gear, the axial depth of the depressions and thus also the height of the elevations may be selected if the thrust plate is produced by forming. It is conceivable that the first and second contact surfaces lie in a common plane, which is useful if the axial width of the cage corresponds to the axial width of the planetary gear. However, if the cage is somewhat longer, the second contact surface may be set back axially relative to the first contact surface, i.e., the cage which protrudes slightly from the planetary gear is guided in a second contact surface which is correspondingly axially offset relative to the first contact surface.

The first depressions can be, radially speaking, deeper than the second depressions. As stated, the first depressions are arranged on the outer circumference, or offset further outwards, and are open radially outwards. Between these depressions, the undeformed plate main body forms the first contact surface for the planetary gear, which runs against it with its end face. On the one hand, because of pockets that are correspondingly deep in radial terms, the entire contact surface can be reduced accordingly so that the frictional contact provided by the segmented first contact surface of the planetary gear end face can be reduced. On the other hand, this naturally results in a correspondingly large pocket volume, so the reservoir volume is correspondingly large.

The depressions, e.g., the outer first depressions, are expediently designed to be slightly trapezoidal so as to produce a correspondingly large, radial catch opening cross-section.

To further improve the lubricant feed, but also the discharge, it is conceivable to provide a lubricant guide structure guiding the inflowing or outflowing lubricant on the cage on at least one axial side, if necessary on both. This lubricant guide structure, which can be realized by a corresponding profile in the axial end region of the cage, can therefore also have a positive effect on the lubricant feed or discharge.

It is conceivable to realize the lubricant guide structure by means of a profile formed on an axial end face of an annular rim of the cage and/or a profile formed on the inner and/or outer circumference of the annular rim and/or by means of a cage edge that widens conically in diameter towards a free end and/or by means of grooves provided on the outer sides of the ribs and extending along the ribs. For example, the axial end faces of the annular rims can be provided with a profile of alternating depressions and elevations, for example in the form of a wave profile. As a result, a channel structure or pocket structure can also be realized in this region, via which lubricant flowing in radially from the sun side can be received.

Alternatively or additionally, it is also conceivable to provide corresponding profiles in the form of alternating elevations and depressions on the outer circumference and/or inner circumference of the radial rim, which serve to axially convey the lubricant into the rolling body region. The cage edge can also widen in diameter in a quasi-conical manner so as to define an obliquely extending annular catching surface, via which the radially flowing lubricant is received and deflected axially in the direction of the bearing region. Such a cage projects axially beyond the planetary gear so that the radially fed lubricant impinges directly on the catching cone.

Furthermore, alternatively or additionally, each rib can be provided on its outer side with a longitudinal, groove-like depression, which on the one hand receives and guides lubricant to the axial line, but on the other hand can also serve as a lubricant reservoir and supply the friction region of the cage guided externally in the planetary gear bore with lubricant. Different designs are therefore conceivable with regard to possible lubricant guide structures on the cage side.

In addition to the lubricating device itself, the disclosure further relates to a planetary transmission with a planetary carrier including two carrier webs, at least one bearing pin arranged on the carrier webs, an anti-friction bearing arranged on the bearing pin, a planetary gear mounted via the anti-friction bearing and two thrust plates which are arranged on both sides of the planetary gear between the planetary gear and the planetary carrier and each have contact surfaces for the planetary gear and the anti-friction bearing, and including a lubricating device of the type described above.

The planetary transmission may be part of a drive train of an electric drive such as an electric axle or a hybrid drive train. In addition to a sun gear unit, it has a planetary carrier with a bearing pin, as well as a planetary gear mounted on the bearing pin via an anti-friction bearing. According to the disclosure, as already described above with regard to the lubricating device, one or both carrier webs are provided with corresponding channel-like depressions, and optionally the thrust plate or both thrust plates are also provided, i.e., are shaped, with corresponding profiles.

Such a lubricant guide structure is expediently provided on both sides of the planetary gear, such that on the one hand there is a defined inlet side, via which the lubricant is primarily fed to one side of the gear, and a defined outlet side, via which the lubricant flowing axially through the anti-friction bearing is largely discharged axially. This means that the lubricant introduced on one side of the planetary gear is distributed from there in the bearing region and then flows out again, which happens on the other side of the planetary gear. To a certain extent, e.g., if appropriately profiled thrust plates are provided on both sides, at least a corresponding lubricant outflow will be provided on both sides of the gear, but since the lubricant on the inlet side is given an axial flow direction which conveys it quasi axially into the bearing region, the majority of the lubricant will flow out on the opposite outlet side.

As described, the cage can have a width that corresponds to the width of the planetary gear. Alternatively, it can also project axially beyond the planetary gear, which means that the lubricant fed radially from the sun gear side can also flow directly onto the annular rim of the cage or a lubricant guide structure provided there, which further improves the supply to the rolling region, e.g., if a corresponding lubricant guide structure is provided on the annular rim via the profile.

### BRIEF DESCRIPTION OF THE DRAWINGS

The present disclosure is explained below on the basis of exemplary embodiments with reference to the drawings. The drawings are schematic representations, in which:

FIG. 1 shows a schematic diagram of a planetary transmission according to the disclosure in a sectional partial view with a lubricating device according to the disclosure;

FIG. 2 shows an enlarged partial view of the region II from FIG. 1, in perspective view;

FIG. 3 shows an enlarged partial view of the region III from FIG. 1, in perspective view;

FIG. 4 shows a top view of a thrust plate of the planetary transmission from FIG. 1;

FIG. 5 shows a sectional view through the thrust plate from FIG. 4 along the line V-V;

FIG. 6 shows a sectional view along the line VI-VI from FIG. 4;

FIG. 7 shows a perspective view of a cage of a first embodiment that can be used in a planetary transmission according to FIG. 1;

FIG. 8 shows a side view of the cage from FIG. 7;

FIG. 9 shows a sectional view of the cage from FIG. 8;

FIG. 10 shows a perspective view of an anti-friction bearing comprising such a cage;

FIG. 11 shows a perspective view of an anti-friction bearing of a further embodiment with a cage of a second embodiment;

FIG. 12 shows a longitudinal sectional view of the anti-friction bearing from FIG. 11;

FIG. 13 shows a perspective view of a further usable anti-friction bearing with another embodiment of a cage;

FIG. 14 shows a longitudinal sectional view of the anti-friction bearing from FIG. 12;

FIG. 15 shows a perspective view of an anti-friction bearing of a further embodiment with a cage of another design;

FIG. 16 shows a top view of the anti-friction bearing from FIG. 15;

FIG. 17 shows a longitudinal sectional view through the anti-friction bearing from FIG. 15;

FIG. 18 shows a perspective view of a usable anti-friction bearing of a further embodiment with a cage having an integrally formed thrust plate;

FIG. 19 shows an enlarged partial view of the anti-friction bearing from FIG. 18 with the integrally formed thrust plate;

FIG. 20 shows a sectional view through the annular rim together with the integrally formed thrust plate in the region of a rib; and

FIG. 21 shows a sectional view through the annular rim together with the integrally formed thrust plate in the region of a pocket.

### DETAILED DESCRIPTION

FIG. 1 shows a section of a planetary transmission 1 according to the disclosure. Such a planetary transmission 1 includes a sun gear unit having an axis of rotation which defines the main axis of rotation of the transmission. The sun gear unit includes a sun gear and a sun shaft, the sun gear being arranged on the sun shaft and being either a separate, attached component or integral with the sun shaft. Usually, a plurality of planetary gears rotatably mounted on a planetary carrier mesh with the sun gear, with the sun gear being arranged concentrically within the planetary gear arrangement. The planetary gears also mesh with a ring gear surrounding them. The basic structure of such a planetary transmission is known.

The detail of a planetary transmission shown in FIG. 1 shows the planetary carrier 2, here including two webs 3a and 3b, to which corresponding bearing pins 4 are attached, of which only one is shown in FIG. 1. Such a bearing pin 4 is a simple, solid-material pin. It extends from one carrier web to the other.

A planetary gear 8 is rotatably mounted by an anti-friction bearing 5 including a cage 6 and the rolling bodies 7 held or guided therein. The planetary gear 8 has an external tooth system with which it meshes on the one hand with the sun gear and on the other hand with a ring gear (not shown).

A thrust plate 9 is arranged between the planetary gear 8 and the anti-friction bearing 5 as well as each carrier web 3a, 3b, against which thrust plate the planetary gear 8 can run with its axial end face as well as the cage 6 with its annular rims, and is thus axially supported there. Each of the thrust plates 9 is axially supported on one side on the carrier web 3. Each thrust plate 9 has a first contact surface 10 against which the planetary gear 8 runs. Furthermore, each thrust plate 9 has a second contact surface 11, which is located radially further inward and against which the cage 6 runs with an axial end face of its annular rim.

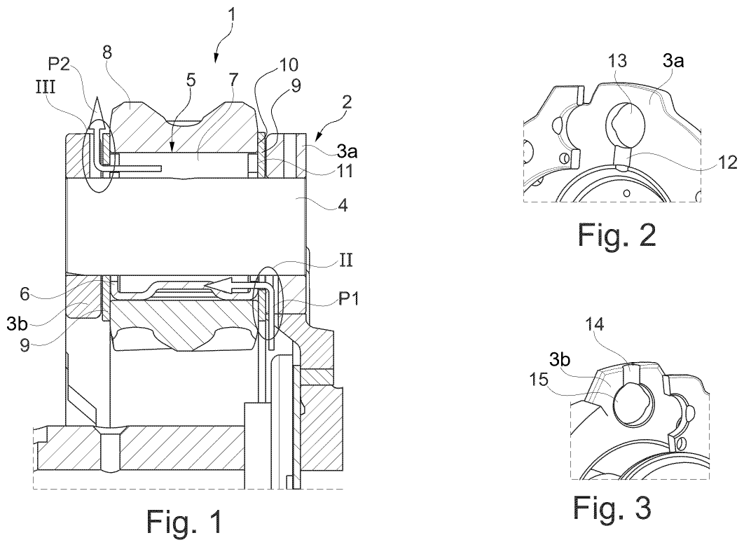

In order to supply the bearing region with lubricant, the two carrier webs 3a, 3b have a corresponding profile, as shown in FIGS. 2 and 3. FIG. 2 shows a perspective view of the carrier web 3a shown on the right in FIG. 1, while FIG. 3 shows the carrier web 3b shown on the left in FIG. 1.

According to FIG. 2, the carrier web 3a is provided with an embossed, for example, channel-like depression 12 which is introduced into its surface and which on the one hand opens radially inwardly and on the other hand into a corresponding through-hole 13 in which the bearing pin 4 is received. This elongated, channel-like depression 12 runs radially, i.e., perpendicular to the central axis of rotation of the planetary transmission. Because it opens radially on the inside, it is possible to feed lubricant from the radial inside, i.e., from the sun gear side, as shown by the arrow P1. This lubricant can enter radially into the depression 12 and reach the region of the bearing pin 4 on the one hand, but on the other hand also axially inwards into the actual rolling region. For this purpose, the adjacent thrust plate 9 may have corresponding cut-outs on the inner circumference, which open the thrust plate 9 axially so that the lubricant flowing in via the depression 12 can enter axially into the bearing region.

The opposite, second carrier web 3b is also provided with a corresponding channel-like depression 14, which, however, is positioned offset by 180° from the first depression 12 in relation to the longitudinal axis of the bearing pin. It is also elongated and opens on the one hand in the through-hole 15 there, in which the bearing pin 4 is received, and radially on the outer side of the carrier web 3b. This ensures that fluid flowing in from the inside of the bearing can be discharged radially again, as shown by arrow P2.

This makes it possible to supply lubricant from the radial inside, i.e., from the side of the sun gear. The sun gear unit is shown here in its basic form. A radial feed channel is provided through which the lubricant is brought into the region of the planetary gear set from the radial inside. The local feed can be arranged so that it occurs primarily from the right-hand side of the gear shown in FIG. 1, such that the lubricant enters primarily there, according to arrow P1. It passes radially outwards via the radial guide channel formed by the depression 12, always driven by centrifugal force, where it is then axially deflected and flows axially into the rolling region through the cut-outs on the thrust plate 9 which are already described. There it flows further, thus wetting all the regions to be lubricated, and then, again driven by centrifugal force, reaches the region of the outlet due to its axial flow component and there into the outlet channel formed by the depression 14 there, where it is then expelled radially outwards, again driven by centrifugal force. In this way, a defined lubricant feed can be realized on a designated inlet side, where the primary lubricant volume flows in, as well as a defined lubricant discharge on a discharge side, as FIG. 1 clearly shows.

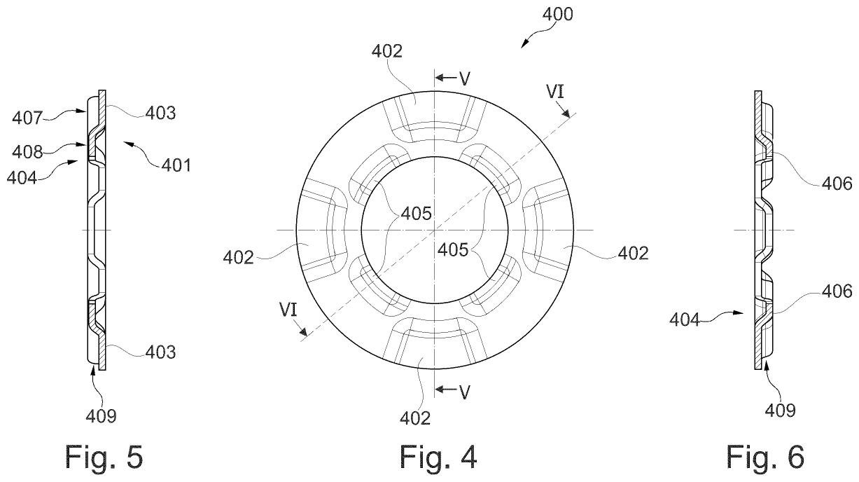

FIGS. 4 to 6 show an exemplary embodiment of a thrust plate 400, which can be integrated as a thrust plate 9 in the planetary transmission 1 from FIG. 1. The thrust plate 400 is annular and has a special profile. It has first depressions 402 introduced in an outer plate section from one plate side 401, which lead as indentations to corresponding elevations 403 on the opposite plate side 404. In the example shown, four such depressions 402 or elevations 403 are provided, which are distributed equidistantly around the circumference of the thrust plate 400. As the figures show, the depressions 402 are open towards the outer circumference, but closed in the circumferential direction e.g., towards the inner circumference. In the example shown, they extend over slightly more than half the width of the annular plate body.

Furthermore, second depressions 405 are provided, which are formed on an inner plate section and lead to corresponding elevations 406 on the opposite plate side 404. These second depressions 405, which are open towards the inner circumference, are also closed in the circumferential direction and towards the outer circumference; they extend only over approximately ⅓ of the width of the plate body, as shown in FIG. 4. Here, too, four depressions 405 distributed equidistantly around the circumference and, of course, corresponding elevations 406 are provided.

The elevations 403 and 406 are flat elevations, i.e., they have flat side surfaces. In the assembly position, these flat elevations 403, 406 each bear against the carrier web. The opposing surfaces of the plate main body form a first segmented contact surface 407, against which the end face of the planetary gear 8 runs in the assembly position. In contrast, the surfaces of the plate main body opposite the second flat elevations 406 form a second contact surface 408 disposed radially further inward, against which the cage 6 runs. This second contact surface 408 is also segmented. Owing to the segmentation of the two contact surfaces 407, 408, only a smaller contact area is provided between the thrust plate 400 and the planetary gear 8 or the cage 6 so that friction can be reduced.

In the example shown, the two contact surfaces 407, 408 are arranged in a common axial plane, which means that the corresponding elevations 403, 406 protrude axially the same distance from the undeformed plate body. This means that the cage 6 of the anti-friction bearing 7 cannot project axially beyond the planetary gear 8, and can therefore have a maximum axial length equal to that of the planetary gear 8. However, it is also conceivable to arrange the first and second contact surfaces 407, 408 axially offset from one another, i.e., to form the second contact surface 408 axially offset with respect to the first contact surface 407. The second contact surface 408 then protrudes less from the undeformed plate body. This makes it possible to use a cage 6 that projects axially beyond the planetary gear 8 and, associated with this, possibly somewhat longer rolling bodies in the form of needles.

As FIG. 4 shows, the depressions 402, 405 and the resulting elevations 403, 406 are arranged offset from one another in the circumferential direction and positioned in a staggered manner. This results in a channel structure 409 that is open radially both towards the outer circumference and towards the inner circumference, i.e., corresponding channels are formed between the elevations/depressions in the assembly position, through which the lubricant can flow from radially outside to radially inside. In the assembly position, the plate side 404 faces the planetary gear 8, which means that the recessed plate regions are overlapped by the planetary gear. Likewise, the cage extends over the recessed plate regions. This results in corresponding guide channels which are open radially outwards and radially inwards, so that radial flow is possible via this lubricant guide or channel structure 409 provided on both plate sides.

At the same time, the channel-like depression 12, 14 communicates with the lubricant guide or channel structure 409. Via this flow, the lubricant is conveyed into the region of the first and second contact surfaces 407, 408 on the one hand and can lubricate them, and on the other hand the lubricant also flows into the anti-friction bearing region and supplies it. The overlap results in a corresponding branched channel structure 409, and the geometry and size of the channel structure 409 can of course be influenced and adjusted by the corresponding positioning or spacing of the individual depressions/elevations as well as their specific size so that the lubricant inflow can ultimately be controlled in this way.

As described, the thrust plate 400 is disposed with the plate side 404 and thus with the depressions 402, 405 adjacent to the planetary gear 8 and the cage 6. Consequently, the plate side 401 is adjacent to the web 3 of the planetary carrier 2, against which it bears in the case of contact. This results in the planetary gear 8 axially covering the depressions 402 and 405, so that corresponding and then closed pockets are formed by the depressions 402, 405, which pockets serve as lubricant reservoirs. The radially outwardly open pockets, formed by the depressions 402, are filled by the lubricant flowing in from the sun gear side and provide a lubricant reservoir, in particular for the frictional contact between the thrust plate 400 and the planetary gear 8 as well as the cage 6. The pockets formed by the depressions 405 are filled either by a lubricant flow between the thrust plate 400 and the planetary gear 8, i.e., a minimal lubrication gap is left, or virtually from the inside out, i.e., from the side of the bearing pin 4 on which the thrust plate 400 sits. This creates a lubricant reservoir close to the pin. Larger-volume receptacles are also formed on the side facing the carrier web 3 via the structure 409, which lubricate the friction region there.

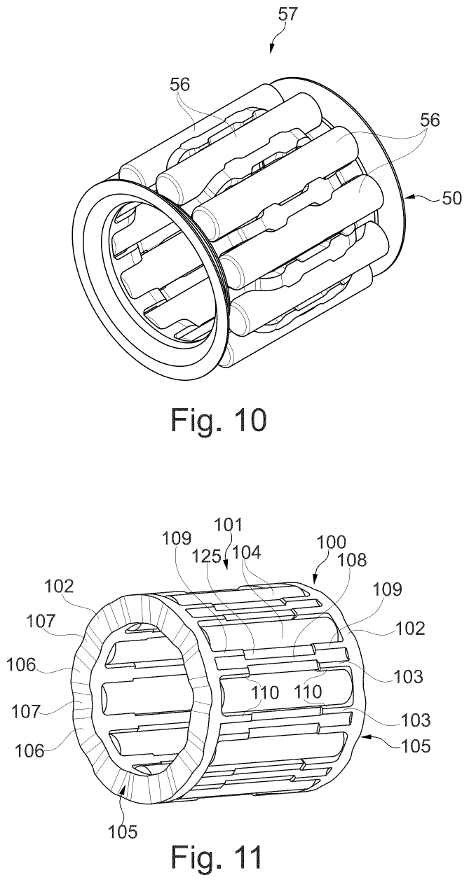

FIG. 7 shows a cage 50 according to the disclosure for an anti-friction bearing, which can be integrated as an anti-friction bearing 5 in the planetary transmission according to FIG. 1. The cage 50, which is made of a metal sheet or of plastic, has two terminal annular rims 51, between which a plurality of ribs 52 extend, which are directly connected at the ends to the annular rims 51. The ribs 52 are, as shown in particular in FIG. 9, W-shaped, i.e., they have a rib center 53 raised radially outwards, to which rib ends 54 that are bent radially inwards are connected on both sides. The annular rims 51 are connected to these rib ends 54. A pocket 55 is formed between each of the two ribs 52, in which a cylindrical, needle-like rolling body 56 is received and guided (see FIG. 10, which shows an anti-friction bearing 57 according to the disclosure).

In the cage 50 according to the disclosure, the two annular rims 51 are funnel-shaped, i.e., they widen in diameter towards their free end, as is clearly shown in particular in FIG. 9. The diameter widening is conical, which means that the funnel-shaped inner surface 58 as well as the corresponding outer surface 59 run straight and at an angle to the longitudinal axis 60 of the cage 50. The angle that the annular rim 51 or the inner and outer surface 58, 59 has to the longitudinal axis 60 is, for example, 45°. It should generally be in the range between 15°-75°, e.g., between 30°-60°.

The outer diameter of the free end edge of the annular rim 51 corresponds at most to the outer diameter in the region of the rib center 53, such that the funnel-shaped annular rim 51 does not protrude radially beyond the web center 53.

The oblique, conical outer surface 59 of each annular rim 51 forms a lubricant guide structure 61, via which, as is discussed below, lubricant, usually oil, flowing in radially from the outside is specifically caught and passed on.

As described, FIG. 10 shows an anti-friction bearing 57 according to the disclosure with a cage 50 according to the disclosure and needle-like rolling bodies 56 inserted in its pockets 55. This anti-friction bearing 57 according to the disclosure serves in particular to support a planetary gear of a planetary transmission on a bearing pin.

This anti-friction bearing 57 is somewhat longer in its axial length than the planetary gear, i.e., the cage with its funnel-shaped annular rims protrudes slightly beyond the end faces of the planetary gear 8 on both sides when viewed axially. Thus, the end faces of the planetary gear 8 and the end edges of the funnel-like widened annular rims are disposed on axially offset planes. This results in the thrust plate having the two contact surfaces on offset planes, which in the case of a thrust plate 400 from FIGS. 4 to 6 can be formed by depressions of different depths.

In the assembly position, the funnel-shaped annular rims 51 with their outer surfaces 59 are freely accessible radially via the lubricant guide or channel structure 409, so the lubricant flowing in on the inlet side according to arrow Pl impinges directly on the outer surface 59, is received there and is deflected axially into the rolling region. The fluid flow on the outlet side is reversed accordingly. The axially longer cage 50 is therefore used to directly receive and pass on the lubricant.

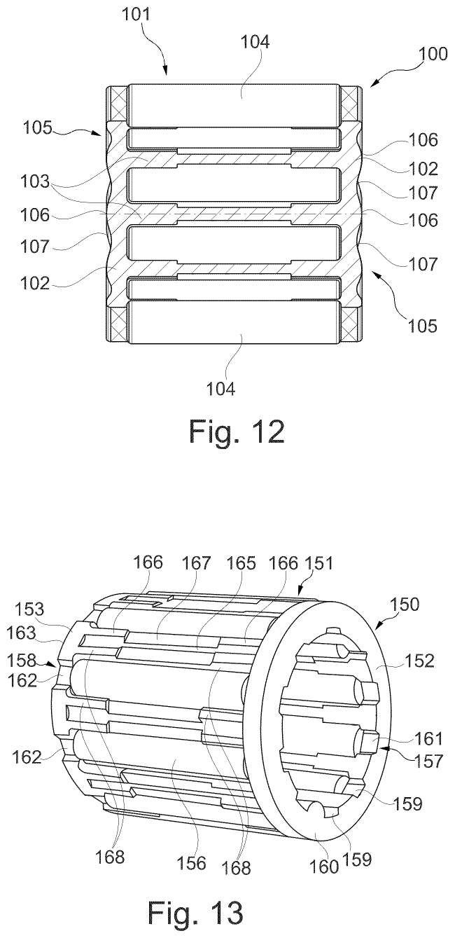

FIG. 11 shows a further embodiment of a cage 100 as part of an anti-friction bearing 101 that can be used in the planetary transmission 1 according to FIG. 1. The cage 100, which may be made of plastic, optionally also of metal, has two axially terminal annular rims 102, as well as a plurality of ribs 103 extending between them and connecting them; see also the sectional view according to FIG. 12 in this regard. Viewed in the circumferential direction, a pocket is formed in each case between two adjacent ribs 103, and a cylindrical rolling body 104 is inserted in each pocket, as shown in the figures. The rolling bodies 104 are cylindrical needles. The annular rims 102 extend radially or have a corresponding radial width, so they each have larger, annular plate-like axial end faces.

In the cage 100 according to the disclosure, each axial annular plate-like end face 105 of the two annular rims 102 is profiled via alternating elevations 106 and depressions 107, the elevations 106 and the depressions 107 being arranged in a symmetrical sequence. The elevations 106 each have flat end faces. They ultimately form the segmented support surface with which the cage 100 runs against an axially adjacent thrust plate.

The depressions 107 are designed in a channel-like manner, so to speak, and extend from the outer circumference to the inner circumference of the annular rim 102 so as to produce a lubricant guide or channel structure that is open radially outwards and inwards. It can be seen that the width of each depression 107, viewed in the circumferential direction, remains the same over its radial length, which means that the flow cross-section does not change. This is useful in order to be able to channel lubricant into the bearing region via said lubricant guide structure.

As FIGS. 11 and 12 show, the elevations 106 and the depressions 107 merge almost continuously into one another so that a wave-shaped profile is formed.

As shown in particular in FIG. 11, a groove-like depression 108 extending over the entire length of the rib is provided on the outer side of each rib 103. This groove-like depression 108 forms a lubricant groove in which lubricant accumulates, which can flow axially along the cage 100 or the anti-friction bearing 101. On the other hand, it also forms a lubricant pocket or a lubricant reservoir, via which the externally guided cage 100 is lubricated in the planetary gear bore in which the anti-friction bearing 101 is accommodated.

Each rib has outer rib sections 109, via which it adjoins flush with the annular rim 102. These rib sections 109, which are somewhat wider in the circumferential direction, form snap sections 110, via which the rolling bodies 104 are held in the pockets. It can be seen that the sections of the depression 108 in the rib sections 109 are wider and deeper than in the central rib section 125, which is recessed relative to the rib sections 109. The depression sections provided in the rib sections 109 form correspondingly large lubricant pockets which allow a corresponding volume to be received.

In the planetary transmission 1, a thrust plate 9 is arranged between the planetary gear 8 and the anti-friction bearing 101 as well as each web 3, against which thrust plate the planetary gear 8 can run with its axial end face, as can the cage 100 with its annular rims 102, and is thus axially supported there. The anti-friction bearing 101 or the cage 100 is not axially longer than the planetary gear 115, i.e., it does not protrude axially, which means that the annular rims 102 are flush with the end faces of the planetary gear 115. In principle, however, it would also be conceivable, with a correspondingly different design of the thrust plates 9, for the cage 100 to project slightly beyond the planetary gear axially.

Each of the thrust plates 9 of FIG. 1 has a first contact surface which is formed by the plate body. The plate body of the thrust plate 9, e.g. in the form of the thrust plate 400, further forms a radially inner second contact surface, which, for example, lies on the same plane as the first contact surface and, like the first contact surface, can be segmented, but can also be present as an undeformed annular plate. The cage 100 runs against it with its annular rims 102 or with the wave profile formed there. The radial width of each annular rim 102 can be slightly larger than the radial width of the second contact surface, which leads to the wave-shaped profile of the radial rims 102, i.e., in particular the radially open depressions 107, overlapping with the depressions provided on this plate side. This results in the lubricant guide structure, formed by the structuring of the thrust plate 9 and defined by the depressions formed on the planetary gear side, communicating with the lubricant guide structure formed on the annular rims 102, in particular with the depressions 107 there.

The lubricant is caught on one side of the planetary gear and fed to the lubricant guide structure which is configured between the planetary gear 8 or the carrier web 3 and the thrust plate 9 and formed among other things via the depression 12; see arrow Pl in FIG. 1. The lubricant flows radially outwards via these and reaches the region of the depressions 107 on the cage 100, where it is firstly received and distributed in the friction region to the thrust plate 9, but secondly is also passed on radially and brought into the region of the rolling bodies. At the same time, the lubricant also flows into the groove-like depressions 108. Overall, a sufficiently large quantity of lubricant is guided radially from the outside to the radial inside into the actual rolling region, where it is distributed axially, as indicated by the arrow P1.

The lubricant is to a certain extent guided axially through the anti-friction bearing 101. On this bearing side shown on the left in FIG. 1, the lubricant is discharged outwards again, on the one hand by flowing out of the groove-like depressions 108, and on the other hand by flowing radially outwards through the depressions 107 on the annular rim 102 there and the depressions on the thrust plate 9 there, driven by centrifugal force, where it is flung off. This fluid path is shown by the arrow P2.

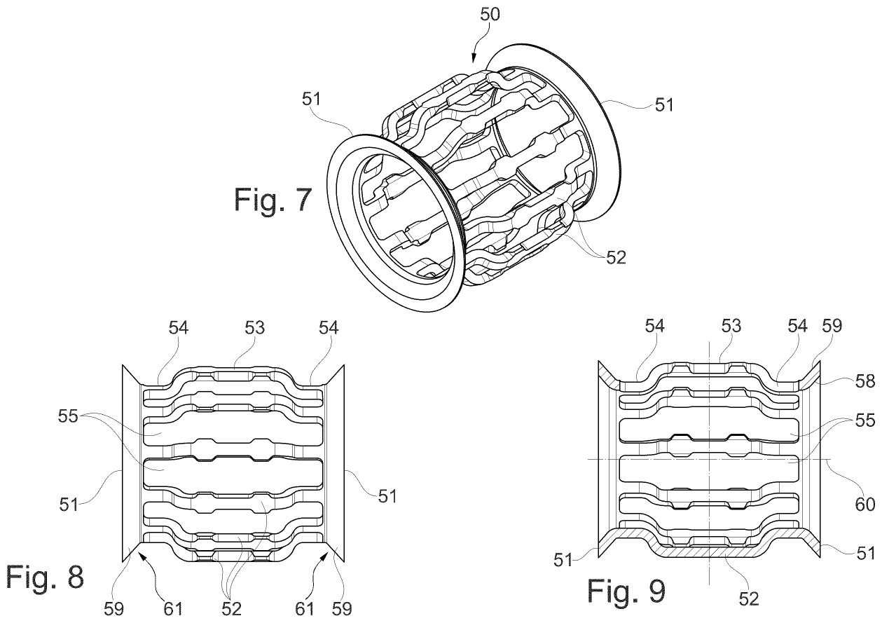

As described, it is possible for the cage 100 to also project axially beyond the planetary gear 8 on both sides. In this case, the thrust plate 9 would have to be profiled somewhat differently, as already described above for the embodiment of the cage according to FIGS. 7 to 9. This is because there would then have to be an axial offset between the first contact surface 10 and the second contact surface 11.

FIG. 13 shows a further embodiment of a cage 150 which is part of an anti-friction bearing 151 according to the disclosure, which can be used as an anti-friction bearing 5 in the planetary transmission 1 according to FIG. 1. The cage 150 may be made of plastic, but can also be made of metal. The cage 150 has a first, axially terminal annular rim 152 and a second axially terminal annular rim 153, between which ribs 154 extend. The annular rims extend radially or have a corresponding radial width, so they each have larger, annular plate-like axial end faces. A pocket 155 is formed in each case between two adjacent ribs, and a cylindrical, needle-like rolling body 156 is inserted in each pocket. The first annular rim 152 is provided with a first lubricant guide structure 157, while the second annular rim 153 is provided with a second lubricant guide structure 158. These serve for the targeted guidance or channeling of a lubricant fed radially from the outside, which is discussed below in connection with FIG. 3.

The first lubricant guide structure is configured in the form of a first profile on the inner circumference of the annular rim 152 only on the inner circumference; the outer circumference is not profiled. This profile is realized by means of a plurality of first depressions 159 arranged offset in the circumferential direction, with each depression 159 being arranged in extension of a pocket 155. The depressions 159 are all open both to the axial end face 160 of the annular rim 152 and to each pocket 155. In the example shown, the floor surface 161 of each depression 159 runs parallel to the longitudinal axis of the cage 150.

Via this first lubricant guide structure 157, i.e., the individual depressions 159, a lubricant fed from radially outside the cage can be fed axially directly into the region of the individual rolling bodies 156. The lubricant passes axially into the depressions 159 and from there directly to the rolling bodies 156, i.e., into the pockets 155. Owing to the axial deflection via the depressions 159, the lubricant, usually an oil, experiences an axial flow component so that it flows axially through the anti-friction bearing 151, as is discussed below.

The second lubricant guide structure 158 on the second annular rim 153 is also formed by a profile, but it is disposed on the outer circumference of the annular rim 153, whereas here the inner circumference is not profiled. This profile is also realized via a plurality of depressions 162 arranged distributed in the circumferential direction, which are open axially towards the end face 163 of the second annular rim, as well as axially towards the adjacent pocket 155. This means that here too there is a direct opening to the rolling body 156.

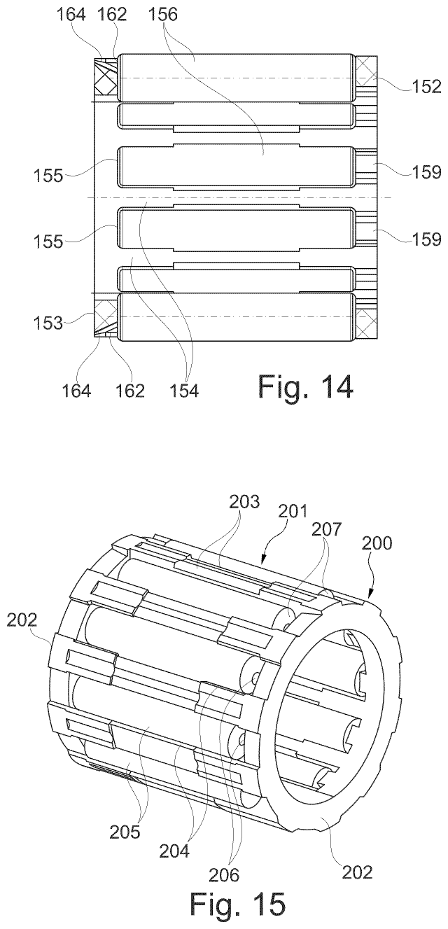

The lubricant flowing axially through the anti-friction bearing 151 then passes from the actual rolling body or bearing region into the region of the second depressions 162, via which it is then guided axially out of the rolling body 151, from where it is then discharged. The floor surface 164 of the depressions 162, as shown in particular in FIG. 14, runs obliquely in a ramp-like manner, sloping from the end face 163 to the pocket 155.

As shown in particular in the view according to FIG. 13, each rib is further provided with a groove-like depression 165 which extends over the entire length of the rib. Each rib has two first rib sections 166, via which it adjoins the annular rim 152, 153 in a manner flush with the outer side of the annular rim 152, 153. The first rib sections 166 are slightly wider than the central rib section 167, since corresponding snap projections 168 are provided on them which protrude into the pockets and by means of which the rolling bodies 156 are held.

As FIG. 13 shows, the sections of the depression 165 which are provided in the rib sections 166 are wider and deeper than in the central rib section 167. In this way, lubricant reservoirs of corresponding volume can be formed in the regions of the annular rims 152, 153, in which a lubricant volume can be held, by which the frictional contact between the externally guided cage 150 and the planetary gear bore can be lubricated. In the central rib section 157, the depression is narrower and flatter; this region is primarily used for axially conveying the lubricant.

If the anti-friction bearing 151 is integrated in the planetary transmission 1 from FIG. 1, the lubricant is fed via the sun gear, i.e., from radially inside into the planetary gear ring. The lubricant is caught on one side of the planetary gear and fed to the lubricant guide structure which is configured between the planetary gear 8 and the thrust plate 9, again, for example, in the form of the thrust plate 400, and which is formed via the depressions/elevations; see arrow P1 in FIG. 1. The lubricant flows radially outwards via these and reaches the region of the depressions 159 provided on the inner circumference of the cage 150, where it is received and passed on axially and brought into the region of the rolling bodies. At the same time, the lubricant also flows into the groove-like depressions 165. Overall, a sufficiently large quantity of lubricant is guided radially from the outside to the radial inside into the actual rolling region, where it is distributed axially, as indicated by the arrow P1.

The lubricant is to a certain extent guided axially through the anti-friction bearing 151 after the lubricant experiences an axial flow component to the other side of the bearing via the thrust plate 9, through which it is fed, as well as the cage 150. On this bearing side shown on the left in FIG. 1, the lubricant is discharged outwards again, on the one hand by flowing out of the groove-like depressions 165, and on the other hand by flowing radially outwards through the depressions 162 on the annular rim 153 there and the depressions on the thrust plate 9 there, driven by centrifugal force, where it is flung off. This fluid path is shown by the arrow P2.

As described, it is possible that the cage 150 does not have the same length as the planetary gear 8, but can also project axially beyond the planetary gear 8 on both sides. In this case, the thrust plate 9 or 400 would have to be profiled slightly differently, as already described. This is because there would then have to be an axial offset between the first contact surface and the second contact surface, which can be achieved by changing the depth of the depressions.

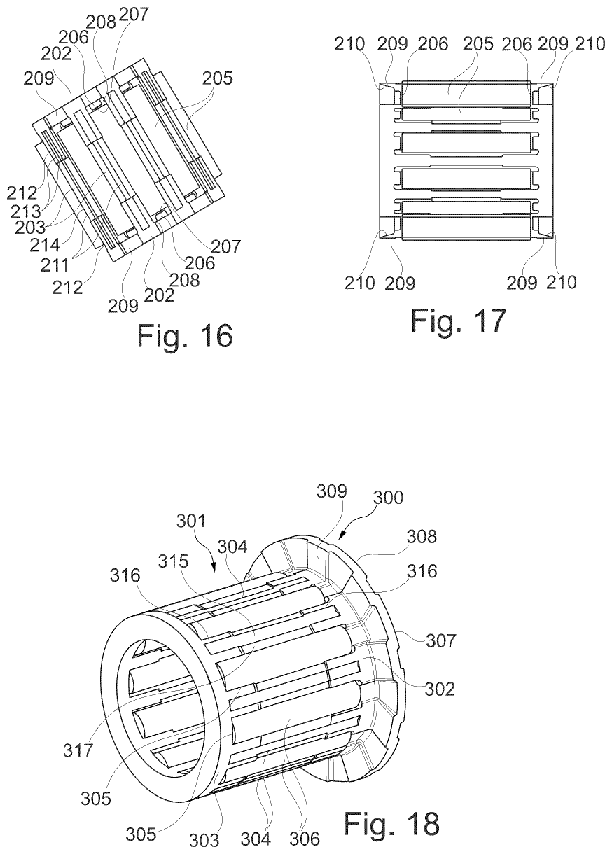

FIGS. 15 to 17 show a further embodiment of a cage 200 as part of an anti-friction bearing 201, which can be used as an anti-friction bearing 5 in the transmission 1 according to FIG. 1. The cage 200, which may be made of plastic, but optionally also of metal, has two axially terminal annular rims 202, as well as a plurality of ribs 203 extending between them and connecting them; see also FIGS. 16 and 17. Viewed in the circumferential direction, a pocket 204 is formed in each case between two adjacent ribs 203, and a cylindrical rolling body 205 is inserted in each pocket, as shown in the figures. The rolling bodies 205 are cylindrical needles.

In the cage 200 according to the disclosure, each annular rim 202 is provided with a spacer 206 on its inner side, i.e., the side to which the ribs 203 are connected. The spacer 206 projects axially into the pocket 204. It can be seen that each rolling body 205 has an axial end face 207 axially adjacent to and at a small distance from the spacer 206. During operation, the rolling body 205 runs with its end face 207 axially against the spacer 206 and is thus supported on it. The spacer itself can be completely cylindrical, but it can also be only partially cylindrical, as shown in the figures, i.e., it can have a quasi-semicircular shape, with the outer side being rounded, as shown in FIG. 16, while the inner side, as shown in FIG. 15, is quasi-flat or only slightly curved according to the inner circumference.

As can be seen, an opening 208 which is open radially outwards and inwards is thus formed at the end of the pocket and extends to both sides of the spacer 206 arranged centrally on the annular rim, after which the spacer 206 is also arranged adjacent to the two adjacent ribs 203. This means that a radially open lubricant guide structure can be formed on both cage rims 202.

Furthermore, each of the annular rims 202 is provided on the outer circumference in the region between two ribs 203 with a radial depression 209 which is axially open on both sides and is therefore open both towards the axial end face of the annular rim 202 and towards the pocket 204. As shown in particular in the sectional view according to FIG. 17, the bottom 210 of each depression slopes down towards the pocket in a ramp-like manner, i.e., an oblique surface is formed which further facilitates the inflow and outflow of the lubricant.

Finally, as shown in particular in FIG. 16, a groove-like depression 211 extending over the entire length of the rib is provided on the outer side of each rib 203. This groove-like depression 211 forms a lubricant groove in which lubricant accumulates, which on the one hand can flow axially along the cage 200 or the anti-friction bearing 201 and can thus get from one side of the anti-friction bearing 201 to the other side. On the other hand, this also forms a lubricant pocket or a lubricant reservoir, via which the externally guided cage 200 is lubricated in the planetary gear bore in which the anti-friction bearing 201 is accommodated.

Each web has outer rib sections 212, via which it adjoins flush the annular rim 202. The rib sections 212, which are somewhat wider in the circumferential direction, form snap sections 213, via which the rolling bodies 205 are held in the pockets 204. It can be seen that the sections of the depression 211 in the rib sections 212 are wider and deeper than in the central rib section 214, which is recessed relative to the rib sections 212. The depression sections provided in the rib sections 212 form correspondingly large lubricant pockets which allow the corresponding volume to be received.

In the assembly position, the lubricant flows (see the arrow P1 in FIG. 1) into the radially outwardly open, channel-like lubricant guide structure between the planetary gear 8 or carrier web 3 and the thrust plate 9, again, for example, in the form of the thrust plate 400. It passes from the radial outside to the outer circumference of the adjacent radial rim 202, where it enters, among other things, the depressions 209, which, as described, have a slightly oblique, ramp-like floor surface. The lubricant is diverted via this, it then flows (see the arrow P1) axially through the anti-friction bearing 201, and it also flows into the corresponding openings 208 and consequently supplies the entire bearing or rolling region both on the planetary pin 4 and on the inner circumference of the planetary gear 8 with lubricant.

Owing to this deflection, the lubricant experiences an axial flow component, it flows axially through the anti-friction bearing 201 and is discharged on the opposite side due to centrifugal force, as shown by the arrow P2. It flows axially outwards again from the openings 208, as well as into the depressions 209, after which it enters the lubricant guide structure also formed on this side or the thrust plate 9 there and is driven radially outwards through the channels or gaps also formed there. This means that ultimately there is a defined inlet side and the lubricant is fed from the sun gear side to only one side, while a large part of the lubricant flows out again on the opposite outlet side. Of course, a certain proportion also flows out radially on the inlet side, since the lubricant guide structure on the cage also supplies the friction and contact areas of the cage 200 as well as the planetary gear 8 at the contact surfaces of the thrust plate 9 with lubricant, which also applies to the region of the thrust plate 9 on the opposite outlet side.

A certain proportion of lubricant naturally also flows into the depressions 211 formed on the outside of the ribs 203 and accumulates therein. On the one hand, this supplies the frictional contact of the cage 200 to the planetary gear bore with lubricant, and on the other hand, a certain axial flow of the lubricant can also take place via this.

Again, the cage can be axially flush with the planetary gear, or it can project slightly axially beyond it, which then results in a slightly different design of the thrust plate, as described.

FIGS. 18 to 21 show another example of a cage or anti-friction bearing for a planetary transmission 1 according to FIG. 1. FIG. 18 shows a cage 300 as part of an anti-friction bearing 301. The cage includes a first annular rim 302 on one axial side and a second annular rim 303 on the opposite side. A plurality of ribs 304 extend between the annular rims 302, 303, connecting them, and a pocket 305 is formed in each case between two adjacent ribs 304, in each of which a cylindrical, here needle-like, rolling body 306 is received.

At the end of the first annular rim 302, an annular plate-like flange section 307 extending radially outwards from the annular rim 302 is arranged in one piece on the cage 300 including plastic, optionally also including metal, which can also be referred to as a crank pin cage. The flange section 307 is axially slightly offset with respect to the annular rim 302, as shown in FIGS. 20 and 21. This means that it protrudes somewhat axially from the annular rim 302. This makes it possible, in the assembly position, to arrange the flange section 307, as viewed axially, between a planetary gear of a planetary transmission and its planetary carrier or the carrier web, such that a thrust plate for the planetary gear is simultaneously provided by this flange section 307. This is because the outer diameter of the flange section 307 is larger than the inner diameter of the planetary gear bore in which the anti-friction bearing 301 and thus also the cage 300 are accommodated, so, as viewed axially, an overlap is produced between the end face of the planetary gear and the flange section 307. In the assembly position, the flange section 307 is disposed with a first side surface 308 facing away from the rolling bodies 306 adjacent to the planetary carrier or the web, such that the cage is supported with said plate side 308 against the web and runs against it. The second plate side 309, which faces the rolling bodies 306, forms the contact surface for the planetary gear.

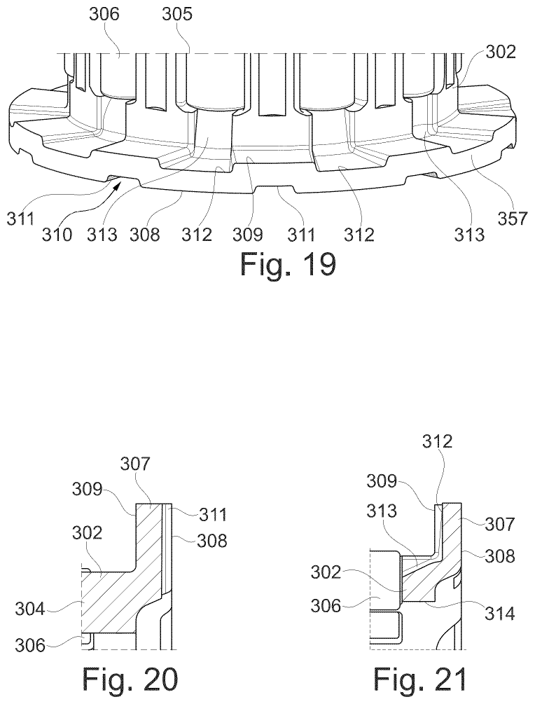

As FIG. 18, but in particular FIG. 19, shows, the flange section 307 is provided with a lubricant guide structure 310. For this purpose, a plurality of depressions 311 are provided on the first plate side 308, equidistantly offset in the circumferential direction, and extend over the entire width of the flange section 307 or the plate side 308, i.e., are open radially outwards and inwards. As FIG. 18 clearly shows, the depressions 311, which are channel-like, are arranged in the axial extension of the ribs 304.

On the opposite, second plate side 309, depressions 312 are also provided, which are also channel-like, i.e., elongated, and are also open radially outwards, but open radially inward to the annular rim 302. These depressions 312 are arranged in the axial extension of the pockets 305, i.e., in the axial extension of the rolling bodies 306, as clearly shown in FIG. 19.

As a result, as shown in the side view according to FIG. 19, but also FIG. 18, a meandering structure is formed by the flange section 307, which is formed on both plate sides 308, 309 by the depressions and resulting elevations introduced there. Since the depressions 311, 312 are open radially outward as described, a lubricant can consequently be fed radially from the outside, which is discussed below.

As already shown in FIG. 19, but also FIG. 21, the annular rim 302 is also profiled on the outer circumference. Also in the axial extension of the pockets 305, depressions 313 are formed which (see FIG. 21) slope downwards obliquely towards the pocket 305 in a ramp-like manner. Each depression 313 opens firstly into the pocket 305 and secondly into the adjoining depression 312 so as to ultimately produce an angled channel structure, each formed by one depression 312 and 313. The fluid flowing in radially from the outside consequently passes into the depression 312 and via this into the depression 313 and from there, since the lubricant is axially deflected in it, axially into the pockets 305 and to the rolling bodies 306.

The inner circumference of the radial flange 302 is also provided with a profile that is formed by depressions 314 on the inner circumference which are opposite the depressions 313, as FIG. 21 clearly shows in comparison with FIG. 20. This forms an opening cross-section that allows lubricant to flow into the pocket and rolling body region, including lubricant that flows in radially from the outside via the radially outwardly open depressions 311 of the flange section 307. This is because, as FIG. 21 shows, an annular space is formed in the inner circumferential region of the flange section 307 and communicates with the inner circumferential depressions 314 so that the fluid flowing in from this side can also flow into the rolling region.

As FIG. 18 further shows, the ribs 304 are also profiled on the outside. Each rib has a longitudinal, groove-like depression 315 on its outer side, which is used to axially convey the lubricant, but also form a lubricant reservoir. Each rib 304 includes first rib sections 316, which are flush with the respective annular rims 302, 303. Between them, there is a recessed central rib section 317. The groove-like depression 315 extends over all the rib sections, but is wider and deeper in the terminal rib sections 316 than in the central rib section 317. Since the cage 300 is guided on the outside in the planetary gear bore, meaning that frictional contact occurs there, the larger sections of the depression 315 form correspondingly larger-volume lubricant reservoirs that lubricate this frictional contact in the best possible way.

As described, the lubricant guide structure is formed on the flange section 307. In the assembly position, the flange section is disposed between the planetary gear end face and the web; an additional thrust plate (such as the thrust plate 9 shown on the right in FIG. 1) is not provided there. As a result, channel or gap sections which are open radially outwards are formed in the region between the plate side 308 and the web by the depressions 311. Lubricant, usually oil, fed from the radial outside, as shown by the arrow Pl in FIG. 1, can flow via these radially in the direction of the bearing pin and from there via the depressions 314, but of course also via any other free space, into the individual pockets 305 and to the rolling bodies 306.

At the same time, corresponding channel or gap sections are formed in the region between the planetary gear and the plate side 309. Here, too, corresponding channel or gap sections that are open radially outwards are formed via the depressions 312 that are open radially outwards, into which channel or gap sections the lubricant flows from the radial outside according to arrow P1 due to centrifugal force. This lubricant then flows into the communicating depressions 313 and is axially deflected so that it reaches directly into the pockets 305 and to the rolling bodies 306. The arrow P1 firstly represents the radial inflow and secondly represents the axial onward flow. The lubricant therefore experiences an axial flow component so that it can be distributed in the rolling region in an axial flow. Due to centrifugal force, it exits the anti-friction bearing again, as shown by the arrow P2 in FIG. 1. In order to facilitate the discharge on this side as well, the thrust plate there is also provided with a lubricant guide structure, formed by depressions introduced on the plate side facing the planetary gear, which lead to corresponding elevations on the plate side facing the web. These depressions are only formed in the outer plate region, so that an annular plate-like, undeformed main body section remains in the region of the inner circumference of the thrust plate. Since the plate main body is only locally deformed via the depressions, corresponding main body sections remain in the outer circumferential region, via which a first contact surface is formed against which the planetary gear runs. In the region of the inner circumference, the annular plate-like main body section, which is undeformed, forms a second contact surface against which the annular rim 303 of the cage 300 runs.

1. A lubricating device for a planetary gear bearing of a planetary transmission with a planetary carrier comprising two carrier webs, at least one bearing pin arranged on the carrier webs, an anti-friction bearing arranged on the bearing pin, a planetary gear mounted via the anti-friction bearing and two thrust plates which are arranged on both sides of the planetary gear between the planetary gear and the carrier web, wherein at least one channel-like depression is introduced on at least one carrier web in the surface facing the planetary gear, via which depression a lubricant fed from radially outside the thrust plate can be fed to the bearing region in the region between the thrust plate and the carrier web or a lubricant which flows out of the bearing region can be discharged radially to the outside in the region between the thrust plate and the carrier web, wherein on the two carrier webs only one channel-like depression is provided, wherein the depressions are arranged offset about the axis of the bearing pin and the one depression is disposed radially further inward in relation to the axis of rotation of the planetary transmission than the other depression, such that the lubricant flows via the radially further inward depression into the anti-friction bearing, flows axially through same and flows into the radially further outward depression, via which it is drained.

2. The lubricating device according to claim 1, wherein the two depressions are elongated and run with their longitudinal axes perpendicular to the axis of rotation of the planetary transmission.

3. The lubricating device according to claim 1, wherein each carrier web has a through-hole into which the bearing pin is inserted, wherein both depressions open at the through-hole.

4. The lubricating device according to claim 1, wherein, at least between the carrier web comprising a depression and the thrust plate, there is a lubricant gap which is open radially outwards and via which the lubricant can be fed or discharged.

5. The lubricating device according to claim 4, wherein the thrust plate has a plate main body, wherein on a first plate side of the plate main body a plurality of pocket-like first depressions which are open towards the outer circumference and closed towards the inner circumference are provided and optionally a plurality of pocket-like second depressions which are open towards the inner circumference and closed towards the outer circumference are provided, and on an opposite second plate side flat first and second elevations which correspond to the first and second depressions are provided, wherein surface sections of the plate main body which are disposed between the first depressions form a segmented first contact surface and optionally surface sections of the plate main body which are disposed between the second depressions of the plate main body form a segmented second contact surface wherein the first and second elevations are spaced apart from one another in such a way so as to produce a channel structure which is open from the outer circumference to the inner circumference.

6. The lubricating device according to claim 5, wherein the first depressions are arranged in a staggered manner with respect to the second depressions and overlap one another when viewed in the circumferential direction.

7. The lubricating device according to claim 1, wherein a lubricant guide structure guiding the inflowing or outflowing lubricant is provided on a cage of the anti-friction bearing on at least one axial side.

8. The lubricating device according to claim 7, wherein the lubricant guide structure is realized by means of a profile formed on an axial end face of an annular rim of the cage or a profile formed on the inner or outer circumference of the annular rim or by means of grooves provided on the outer sides of the ribs and extending along the ribs and/or by means of a cage edge that widens conically in diameter towards a free end.

9. A planetary transmission with a planetary carrier comprising two carrier webs, at least one bearing pin arranged on the carrier webs, an anti-friction bearing arranged on the bearing pin, a planetary gear mounted via the anti-friction bearing and two thrust plates which are arranged on both sides of the planetary gear between the planetary gear and the planetary carrier and each have contact surfaces for the planetary gear and the anti-friction bearing, comprising a lubricating device according to claim 1.

10. A lubricating device for a planetary transmission, comprising:
a planetary carrier comprising:
two carrier webs;
a bearing pin arranged on the two carrier webs, the bearing pin comprising an axis;
an anti-friction bearing arranged on the bearing pin;
a planetary gear mounted via the anti-friction bearing; and
two thrust plates arranged on either side of the planetary gear between the planetary gear and a respective one of the two carrier webs, wherein:
a one of the two carrier webs comprises:
a surface facing the planetary gear; and
a first channel-like depression arranged on the surface, the first channel-like depression arranged to feed a lubricant from radially outside of the thrust plate to the bearing in a region between the thrust plate and the one of the two carrier webs; and
the other one of the two carrier webs comprises:
a surface facing the planetary gear; and
a second channel-like depression arranged on the surface, the second channel-like depression arranged to discharge the lubricant from the bearing radially outside in a region between the thrust plate and the one of the two carrier webs;
the first channel-like depression is arranged offset about the axis from the second channel-like depression; and
the first channel-like depression is disposed radially further inward than the second channel-like depression in relation to an axis of rotation of the planetary transmission such that the lubricant flows via the first channel-like depression, axially through the anti-friction bearing, and is drained via the second channel-like depression.

11. The lubricating device of claim 10, wherein:
the first channel-like depression is elongated and runs with its longitudinal axis perpendicular to the axis of rotation; and
the second channel-like depression is elongated and runs with its longitudinal axis perpendicular to the axis of rotation.

12. The lubricating device of claim 10, wherein:
the one of the two carrier webs comprises a through hole for receiving the bearing pin and the first channel-like depression opens at the through hole; and
the other one of the two carrier webs comprises a through hole for receiving the bearing pin and the second channel-like depression opens at the through hole.

13. The lubricating device of claim 10 further comprising:
a first lubricant gap arranged between the one of the two carrier webs and a one of the two thrust plates for feeding the lubricant; and
a second lubricant gap arranged between the other one of the two carrier webs and the other one of the two thrust plates for discharging the lubricant.

14. The lubricating device of claim 13, wherein:
each thrust plate comprises a plate main body, the plate main body comprising:
an inner circumference and an outer circumference;
a first side and a second side; and
surface sections;
the first side comprises:
a plurality of pocket-like first depressions which are open towards the outer circumference and closed towards the inner circumference; and
a plurality of pocket-like second depressions which are open towards the inner circumference and closed towards the outer circumference;
the second side comprises:
a plurality of first elevations corresponding to the plurality of pocket-like first depressions; and
a plurality of second elevations corresponding to the plurality of pocket-like second depressions;
the surface sections arranged between the plurality of pocket-like first depressions and the plurality of pocket-like second depressions form a first segmented contact surface; and
the plurality of first elevations is spaced apart from the plurality of second elevations to produce a channel structure that is open from the outer circumference to the inner circumference.

15. The lubricating device of claim 14, wherein the plurality of first pocket-like depressions overlap the plurality of second pocket-like depressions when viewed in a circumferential direction.

16. The lubricating device of claim 10, wherein the anti-friction bearing comprises a cage with a lubricant guide structure for guiding the lubricant.

17. The lubricating device of claim 16, wherein:
the cage comprises an annular rim with an axial end face and the lubricant guide structure comprises a profile formed on the axial end face;
the cage comprises an annular rim with an inner circumference and the lubricant guide structure comprises a profile formed on the inner circumference;
the cage comprises an annular rim with an outer circumference and the lubricant guide structure comprises a profile formed on the outer circumference;
the cage comprises ribs and the lubricant guide structure comprises grooves extending along the ribs; or
the cage comprises a cage edge that widens conically in diameter towards a free end and the lubricant guide structure comprises the cage edge.
